(19) United States
(12) Patent Application Publication
(10) Pub. No.: US 2024/0226894 A1
(43) Pub. Date: Jul. 11, 2024

(54) ACOUSTOFLUIDIC METHODS AND DEVICES USING FLOATING ELECTRODE

(71) Applicant: ACOUSORT AB, Lund (SE)

(72) Inventors: Johan Nilsson, Bjärred (SE); Klara Andersson, Sjöbo (SE)

(73) Assignee: ACOUSORT AB, Lund (SE)

(21) Appl. No.: 18/561,921

(22) PCT Filed: May 25, 2022
(86) PCT No.: PCT/EP2022/064198

§ 371 Date: Nov. 17, 2023

(30) Foreign Application Priority Data
May 25, 2021 (EP) 21175752.1

(51) Int. Cl. B01L 3/00

(52) U.S. Cl. CPC B01L 3/502761; B01L 3/50273; B01L 2300/0645; B01L 2400/0439

(57) ABSTRACT

A method of performing an acoustofluidic operation, comprising the steps of: a. providing (1) an acoustofluidic device (10) comprising:—a substrate (12) in which a microfluidic cavity (30) is positioned, and—at least a first (50a) and a second (50b) ultrasound transducer (50), each provided in acoustic contact with the substrate (12) for transferring ultrasonic vibrations to the substrate and causing the substrate to vibrate, wherein the first and the second ultrasound transducers each comprise a first electrode (52) and a second electrode (56a, 56b) in contact with a piezoelectric or electrostrictive material (54), and wherein the first electrodes are in electric contact with each other, b. providing a fluid, such as a liquid (2) or liquid suspension in the microfluidic cavity (30), c. applying (56a, 56b) of the first and second ultrasound transducers (50a, 50b), wherein the drive signal has a frequency f that corresponds to an acoustic resonance peak of one or more of the substrate, the microfluidic cavity filled with a fluid, and the transducers (50a, 50b), and d. letting the electrical potential of the first electrodes (52) float.

### TECHNICAL FIELD

The technology proposed herein relates generally to the field of acoustofluidics in which ultrasound is used to actuate acoustic fields in fluids such as liquids and suspensions for interacting with the liquids or cells or other particles suspended in the liquids and suspensions, for example for performing inter alia separation, enrichment and sorting of the particles or mixing of liquids or suspensions. The technology proposed herein particularly relates to methods and devices for performing such acoustofluidic operations using at least two ultrasound transducers having a common electrode, wherein the electrical potential of the common electrode is left floating when the acoustofluidic device is in use.

### BACKGROUND

Acoustofluidics generally refers to the use of sound to affect liquids or particles in fluids. Acoustofluidics used to move cells and other particles is generally termed acoustophoresis. Acoustophoresis has been used inter alia for separating different types of cells in suspensions such as separating blood cells from plasma, or for separating and collecting circulating tumour cells from blood. Generally, an acoustofluidic device comprises a microfluidic cavity such as a microfluidic flow channel fashioned in a substrate. The suspension is pumped through the flow channel under laminar flow conditions, or alternatively is stationary in the flow channel. An ultrasound transducer, particularly a piezoelectric element, is attached to the substrate and actuated to produce an ultrasonic vibration in the substrate in the range of about 1-10 Mhz. Provided that the dimensions, in particular height or width, of the flow channel or the dimensions of the whole device is properly matched with the frequency of the ultrasonic vibration, a standing wave may appear in the channel. This standing wave exerts a force on the particles in the suspension dependent on the acoustic contrast of each individual particle as determined by the properties of each particle relative to those of the suspending liquid in the suspension, and thus particles will be forced to move, dependent on the acoustic contrast, towards or away from the pressure node(s) of the standing wave. Applications include, as stated above, separation, sorting, trapping and other manipulations of the particles. More general applications of acoustofluidics involve mixing of liquids. Generally, an acoustofluidic device can be used for both general acoustofluidic operations such as mixing of liquid, as well as for acoustophoretic operations such as manipulating particles.

Generally, as mentioned above, a piezoelectric element, i.e., a solid piece of a piezoelectric material, is used to transduce or convert an input electric signal into the ultrasonic vibration.

Piezoelectric materials inter alia include crystalline materials having non-centrosymmetric crystal structure such as langasite (La₃Ga₅SiO₁₄), gallium orthophosphate (GaPO₄) and lithium niobate (LiNbO₃) and ferroelectric ceramics with randomly oriented grains such as lead zirconate titanate (PZT) with the formula (Pb[ZrₓTi₁₋ₓ]O3 with 0≤x≤1) which is a commonly used piezoelectric ceramics, and Sodium potassium niobate ((K,Na)NbO₃).

To obtain an ultrasound transducer for use in acoustophoresis, a suitably sized solid piece of piezoelectric material is obtained and provided with electrodes for applying the electrical potential over the piezoelectric material.

The suitable dimensions are dimensions such that the natural resonance frequencies of the piece, as governed by its dimensions (e.g., width, length, height), match or otherwise are suitable for the frequency at which it is intended to actuate the ultrasound transducer. Such ultrasound transducers are termed bulk ultrasound transducers in that resonance occurs in the bulk of the transducer itself. This is also referred to as bulk acoustic waves (BAW).

Conventionally, the transducer of the acoustofluidic device is connected to a signal generation device, such as a signal generator or a function generator. The signal generation device generates a signal, the frequency of which may be settable. The output signal may have a form of sine, square, triangular, sawtooth or pulse. The device may be configured to provide amplitude modulation, frequency modulation, and/or phase modulation.

Typically, a transducer of an acoustofluidic device is connected to a signal generating device such that a drive signal is applied to one electrode of the transducer, while the other electrode of the transducer is connected to ground. The resultant varying electrical field throughout the ultrasound transducer then causes the ultrasound transducer to extend and contract to thereby provide ultrasound vibrations.

In some cases, it is desirable to use two ultrasound transducers connected to the same substrate to thereby supply ultrasound vibrations from the two ultrasound transducers to the same substrate. In these cases, it is further often preferred to drive the two ultrasound transducers in an antisymmetric fashion, i.e., with a 180° phase shift between the respective drive signal for the respective ultrasound transducer. The ultrasound transducers may then be driven using two separate signal generation devices or using a signal generation device having two channels for outputting two drive signals, one for each ultrasound transducer.

The need for two drive signals makes the use of two ultrasound transducers more complex than the use of a single ultrasound transducer. This complexity applies to both the need for additional devices and circuitry, as well as the need to account for any potential interference between the drive signals.

There is accordingly a need for methods and devices using two or more ultrasound transducers in a more efficient way.

### Objects

The technology proposed herein aims at obviating or overcoming the aforementio-ned disadvantages.

A primary object of the technology proposed herein is therefore to provide a method of performing an acoustofluidic operation in which a single drive signal is applied to two ultrasound transducers.

A further object of the technology proposed herein is to provide an acoustofluidic device comprising two ultrasound transducers and a drive circuit providing a single drive signal.

### SUMMARY

At least one of the abovementioned objects or at least one of the further objects which will become evident from the below description, are according to a first aspect of the technology proposed herein achieved by a method of performing an acoustofluidic operation, comprising the steps of:
a. providing an acoustofluidic device comprising:
   a substrate in which a microfluidic cavity is positioned, and
   at least a first and a second ultrasound transducer, each provided in acoustic contact with the substrate for transferring ultrasonic vibrations to the substrate and causing the substrate to vibrate, wherein the first and the second ultrasound transducers each comprise a first electrode and a second electrode in contact with a piezoelectric or electrostrictive material, and wherein the first electrodes are in electric contact with each other,
b. providing a fluid, such as a liquid or liquid suspension in the microfluidic cavity,
c. applying a drive signal between the second electrodes of the first and second ultrasound transducers, wherein the drive signal has a frequency f that corresponds to an acoustic resonance peak of one or more of the substrate, the microfluidic cavity filled with a fluid, and the transducers, and
d. letting the electrical potential of the first electrodes float.

At least one of the abovementioned objects or at least one of the further objects which will become evident from the below description, is further, according to a corresponding second aspect of the technology proposed herein, achieved by an acoustofluidic device comprising:
a substrate in which a microfluidic cavity is positioned,
at least a first and a second ultrasound transducer, each provided in acoustic contact with the substrate for transferring ultrasonic vibrations to the substrate and causing the substrate to vibrate, wherein the first and the second ultrasound transducers each comprise a first electrode and a second electrode in contact with a piezoelectric or electrostrictive material, and wherein the first electrodes are in electric contact with each other,

the device further comprising:
a drive circuit configured to apply a drive signal between the second electrodes of the first and second ultrasound transducers,
and wherein the electrical potential of the first electrodes of the first and second ultrasound transducer are floating in relation to ground.

Accordingly, the technology proposed herein is based on the discovery that crosstalk, i.e., interference, between the first and second transducers via the piezoelectric or electrostrictive material, i.e., mechanical interference, and/or via the first electrodes, i.e., as electrical interference, may affect the actual phase shift between two drive signals used to drive the ultrasound transducer. The actual phase shift between the two drive signals may thus differ from the set phase shift between the drive signal, see FIGS. 1B and 1C. When addressing this interference, the present inventors noted that capacitive coupling between the electrodes of an ultrasound transducer could be used to drive two ultrasound transducers using only one drive signal. This approach allows for decreasing the number of the electrical components required for driving two ultrasound transducers, without compromising the efficiency of the acoustofluidic operation, see FIG. 3A. The technology proposed herein accordingly makes use of the phenomena that, as the drive signal is applied between the second electrodes of the first and second ultrasound transducers, the corresponding voltage potentials of these second electrode capacitively and resistively gives rise to a corresponding voltage potential between the first and second electrodes, where the electrical potential of the first electrodes is the same due to the electrical connection between them. The electrical potential of the first electrodes is further floating in relation to ground. By applying the drive signal between the second electrodes, and by letting the electrical potential of the first electrodes float, two electrical fields form.

A first electrical field forms between the second and first electrodes of the first ultrasound transducer. A second, oppositely directed, electrical field forms between the first and second electrodes of the second ultrasound transducer. Provided that the dipoles in the piezoelectric or electrostrictive material are arranged in the same direction, then the differing directions of the first and second electrical fields will provide an asymmetric, i.e., 180°, phase shift between the two ultrasound transducers with only one drive signal applied.

Thus, according to the proposed technology, the drive signal, at least partly, is propagated, or transmitted, from the second electrodes of the first and second ultrasound transducers to the first electrode of the same transducer, capacitively and resistively via the piezoelectric or electrostrictive material. The signal is further transmitted between the first electrodes of the first and second ultrasound transducers as they are in electrical contact. This signal path, due to the directions of the electrical fields and the dipoles of the ultrasound transducers, produces a phase shift of the signal when the corresponding phases of the signal, measured over the two transducers, are compared. The phase shift of the signal contributes to an efficient acoustophoretic process. Thus, it is possible to provide a phase shift of a signal in transducers by applying one signal only to the acoustofluidic device. That is advantageous as it decreases the amount of the electronics required. Moreover, fewer signal outputs are required for operating the acoustofluidic device, which means that a drive circuit as known in the art, may operate twice as many acoustofluidic devices if the acoustofluidic device according to the proposed invention is used instead. This also removes the need to electrically access the first electrodes which may further simplify manufacturing of the acoustofluidic device.

The acoustofluidic operation generally involves affecting a fluid, such as a liquid or suspension, including any particles in the liquid or suspension, and may comprise or consist of an acoustophoretic operation which may include one or more of focusing, i.e. causing particles to move to discrete areas of the microfluidic cavity, trapping, i.e. retaining particles in the microfluidic cavity, separating, i.e. causing different particles (which particle differ in size and/or acoustic contrast compared to the liquid in the microfluidic cavity) to move in different directions and/or with different speeds.

In the context of the technology proposed herein acoustofluidic device is to be understood as encompassing acoustophoretic device, acoustophoresis chip, and acoustophoresis device.

The ultrasound transducer may comprise any type of piezoelectric or electrostrictive material. It is however preferred to use a crystalline material having a non-centrosymmetric crystal structure such as langasite (La₃Ga₅SiO₁₄), gallium orthophosphate (GaPO₄) and lithium niobate (LiNbO₃), lithium tantalate (LiTaO₃), or a ferroelectric ceramic with randomly oriented grains such as lead titanate (PbTiO₃), potassium niobate (KNbO₃), sodium tungstate (Na₂WO₃) lead zirconate titanate (PZT) with the formula (Pb[ZrₓTi₁₋ₓ]O₃ with 0≤x≤1), as well as ceramics such as sodium potassium niobate ((K,Na)NbO₃), bismuth ferrite (BiFeO₃), sodium niobate (NaNbO₃), barium titanate (BaTiO₃), bismuth titanate (Bi₄Ti₃O₁₂), and sodium bismuth titanate (NaBi(TiO₃)₂), for example.

Further materials include lead magnesium niobate (PMN), lead magnesium niobate-lead titanate (PMN-PT), and lead lanthanum zirconate titanate (PLZT).

Other possible materials include molybdenum disulfide which exhibits piezoelectricity also in monolayer form.

The ultrasound transducer may for example comprise a piezoelectric or electrostrictive material selected from the group consisting of zinc oxide, aluminum nitride, scandium-doped aluminum nitride, cerium oxides, and lead-zirconate-titanate.

It may be preferable to exclude lead-zirconate-titanate from the piezoelectric or electrostrictive material comprised by the ultrasound transducer so as to avoid using piezoelectric or electrostrictive material containing lead (Pb).

The ultrasound transducer may be attached to the surface of the substrate by adhesive or connected using another acoustic coupling material. Alternatively, the ultrasound transducer may be deposited onto the surface of the substrate. The substrate may be made from a number of different materials including glass, metal, ceramics, and silicon. It is further contemplated within the context of the technology proposed herein that the substrate may be made from polymeric materials, in particular plastics such as cyclic olefin copolymer (COP), cyclic olefin polymers (COC), polycarbonate (PC), polypropylene (PP) poly(methyl methacrylate) (PMMA), polystyrene (PS), and Polyether Ether Ketone (PEEK). The substrate may have different shapes, lengths, heights, and widths provided that there exists a resonance peak corresponding to resonance in the substrate at a frequency in the ultrasound range, preferably in the range of 0.1 to 20 MHz, more preferably in the range of 0.8 to 8 MHz, most preferably in the range of 1 to 5 MHz.

Typically, the substrate has a bottom surface, an opposing top surface, two opposing side surfaces, and two opposing end surfaces. The length, height and width of the substrate are typically in the range of 10-100 mm (length) 0.5 to 3 mm (height), and 1-10 mm (width). The substrate may for example be as a microfluidic chip or capillary.

The microfluidic cavity may run along at least a part of the substrate and may be provided with inlets and outlets at its opposite ends. The microfluidic cavity may in particular comprise a microfluidic channel. The microfluidic cavity may have a floor, a ceiling, and two opposing side walls. Typically, the microfluidic cavity will have a rectangular or substantially rectangular cross section, although other shapes of cross section are possible. The width of the microfluidic cavity is typically from 0.1 to 1 mm and the height 0.05 to 0.5 mm, depending on the size of any particle that is to pass through the microfluidic cavity. It is to be understood that a liquid or suspension in the microfluidic cavity may, or may not, flow through the cavity.

Preferably, the width the microfluidic cavity can be up to 4 mm and the height of microfluidic cavity can be up to 2 mm.

The microfluidic cavity is positioned in the substrate such that the resonance in the substrate gives rise to acoustic forces on any particle having a different acoustic contrast than the liquid the particle is suspended in. The substrate may be formed in one piece. Typically, however, the substrate is fashioned from two parts so that the cavity may be easily implemented as a trough or groove in one of the parts, a base substrate, whereafter the other part is placed as a lid to seal the trough or groove to form the cavity. The base substate is preferably not a membrane because it is thick enough that, if the ultrasound transducers are attached to it, the base substate transfers the ultrasound vibration to the rest of the substrate so that the whole substrate vibrates. Typically, the base substate has a thickness that is at least as thick as the minimum dimension of the microfluidic cavity, or at least 1/10 of the minimum outer dimension of the substrate.

The ultrasound transducers may be placed at different positions on the substrate. Where the substrate comprises the base substrate in which the cavity is formed as a groove or similar, and wherein a lid substrate is attached to the base substrate to cover and together with the base substrate define the cavity, then the ultrasound transducer may preferably be attached in connection to the base substrate. Alternatively, the ultrasound transducer may be attached to the lid substrate. However, in each case the ultrasound transducer is preferably positioned so that it can cause the whole substrate to vibrate.

Further, the lid substrate or the base substrate may be configured with different dimensions, such that for example the lid substrate has a larger area than the base substrate, such that the base substrate only is attached to a part of a surface of the lid substrate, or vice versa.

The substrate may additionally comprise a further microfluidic cavity, the further microfluidic cavity being positioned so that that an acoustic force arises, due to resonance in the substrate preferably including the microfluidic cavity and the further microfluidic cavity, on a target particle or liquid in the further microfluidic cavity, the acoustic force being the same, or different, from an acoustic force arising on a target particle in the microfluidic cavity. The further microfluidic cavity may have the same dimensions and configuration as described above for the microfluidic cavity.

The cavity may have different dimensions at different positions along its length. The cavity may further branch into plural cavities, or plural cavities may join into one cavity, at different positions along its length. The liquid or liquid suspension may be provided in the microfluidic cavity by pumping, suction, etc. The liquid or liquid suspension may be flowed through the microfluidic cavity or injected and stopped in the cavity.

The fluid is preferably a liquid or a liquid suspension.

The liquid suspension may be a disperse fluid such as undiluted or diluted whole blood, intracellular fluid, interstitial fluid, synovial fluid, peritoneal fluid, urine, yeast cell cultures, bone marrow, stroma, dissociated cells from normal or cancerous tissue, milk. The liquid suspension may comprise particles such as red blood cells, white blood cells, platelets, cancer cells, bacterial cells, viruses, yeast cells, algae, pollen, extracellular vesicles such as microvesicles and exosomes, dust particles, silica particles, magnetic particles, and polymer particles.

The acoustofluidic operation may comprise or be followed by a measurement or optical observation or interrogation in the microfluidic cavity.

The technology proposed herein may take into account the resonance in the entire substrate. In particular the acoustic force may be dependent on the position of a cavity within the substrate, thus providing for obtaining different acoustic forces in different parts of the substrate.

The ultrasound transducers may be in acoustic contact with the substrate by being in direct physical contact, or by being in indirect physical contact via for example an acoustically conducting material, such as an electrode or electrode layer that is used to conduct an electric signal to the ultrasound transducer. The substate itself may act as an electrode.

The ultrasound transducer may be provided in acoustic contact with a majority, such as all, of a surface of the substrate. Alternatively, the ultrasound transducer is provided in acoustic contact with a part of a surface.

The positions and extensions of the ultrasound transducers may be advantageously configured so as to allow the microfluidic cavity to be observed or analyzed through a surface.

The substrate and the ultrasound transducers of the acoustofluidic device may define a form, being a chip form, i.e., flat, and/or capillary form, i.e., elongated. It is understood that the first and second electrodes should be made of an electrically conductive material such as a metal, for example copper, graphite, titanium, brass, silver, and platinum, or gold. Any other suitable material, as metal alloys or non-metal materials may be used, if appropriate. The electrodes may be manufactured of the same material. Alternatively, the at least one of the electrodes may be manufactured from a different material.

Typically, the ultrasound transducer comprises a piezoelectric or electrostrictive material which is caused to vibrate by an electric drive signal. However, it is further contemplated within the context of the technology proposed herein that also other types of ultrasound transducer materials, such as magnetostrictive materials (which change dimension in magnetic fields) and thermoacoustic materials (which emit acoustic vibrations in response to temperature changes) can be used. It is further contemplated within the context of the technology proposed herein that the ultrasound transducers could employ an electrostatic function, whereby vibrations are caused by varying the electrostatic attraction and/or repulsion between electrodes of the ultrasound transducer.

The ultrasound transducer may be actuated by providing an electric signal, such as a sine or square wave signal to the ultrasound transducer in order to force the ultrasound transducer to vibrate at or near the frequency of the actuation signal. Actuating the ultrasound transducer at the frequency f is further to be understood as encompassing supplying ultrasound energy at the frequency f to the substrate. The frequency f is typically in the range of 0.1 to 20 MHz. The voltage of the signal (peak-to-peak) may be 1-30 Vpp, such as 10-20V Vpp. The higher the voltage, the stronger the acoustofluidic effect. The maximum voltage used is limited by the breakdown voltage V/μm thickness of the piezoelectric or electrostrictive material used. The breakdown voltages depend on the piezoelectric or electrostrictive materials used and can generally be in the range of 0.5 to 20, such as 10 to 20 Vpp/μm. The maximum voltage is also limited by the heating of the material during actuation.

The frequency f corresponds to an acoustic resonance peak of one or more of the substrate, the microfluidic cavity filled with a fluid, and the transducers.

Accordingly, the frequency f may correspond to an acoustic resonance peak of the substrate alone, or the substrate including the microfluidic cavity filled with a fluid, or the substrate including the transducers further including the microfluidic cavity filled with a fluid.

The frequency f may preferably to an acoustic resonance peak of the substrate including the microfluidic cavity filled with a fluid such as a liquid or a liquid suspension. In this type of resonance, it is the interface formed by the differing acoustic impedance of the substrate and the surrounding air at the outer surface of the substrate that causes reflection of the sound so that resonance in the whole of the substrate is obtained. This is also called whole body resonance. This resonance could be a one- or two-dimensional standing wave, but is preferably a three-dimensional volume resonance of the whole substrate including the microchannel that may or may not be possible to describe as a one- or two-dimensional resonance or superposition of such resonances.

Alternatively, the frequency f may correspond to an acoustic resonance peak of the microfluidic cavity filled with a fluid such as a liquid or a liquid suspension. In this case it is the differing acoustic impedance of the boundary between he liquid and the walls of the cavity that causes reflection of sound so that resonance may occur. The term “a resonance peak of” encompasses any resonance peak of the concerned feature (substrate, cavity, transducer) whether they apply to the whole or only to a part of the feature.

The signal may be provided by a drive circuit such as a function generator. The drive circuit may be separate from the acoustofluidic device.

In the context of the technology proposed herein corresponds is to be understood as preferably, but not exclusively, relating to an exact match of the frequencies—it is contemplated that a satisfactory actuation of the substrate will be possible even where the frequency f differs from the resonance peak by no more than 30%, preferably no more than 20%, more preferably no more than 10%, and most preferably no more than 1% such as no more than 0.1%.

The acoustic resonance peak is the frequency where the acoustic energy in the substrate reaches a maximum. There may be several acoustic resonance peaks for a given substrate, given ultrasound transducers, and microfluidic cavity filled with fluid.

The resonance peak should at least correspond to a resonance peak of a part of the substrate, the substrate in its entirety, or to the microfluidic cavity filled with a fluid such as a liquid or a liquid suspension. Preferably the resonance peak should correspond to the resonance of the substrate including the microfluidic cavity including the fluid inside the cavity.

The electrical potential of the first electrodes is allowed to float, i.e., in relation to ground. This may for example be achieved if the first electrodes are not electrically connected to ground, and/or if the first electrodes are isolated from ground. The potential of the first electrodes is thus free to assume a value dependent on the properties of the drive signal and the ultrasound transducers. Typically, the electrical potential of the first electrodes will be half the potential difference between the second electrodes.

Typically, but not necessarily, no drive signal is applied to the second electrode of the second ultrasound transducer. Preferably the second electrode of the second ultrasound transducer is held at a constant voltage in relation to ground, such as by being grounded.

This means that the only drive signal actively provided to the first and the second transducers is the signal provided to the second electrode of the first ultrasound transducer. The signal propagates through the piezoelectric or electrostrictive material and/or the connection between the first electrodes, and actuates the second transducer. Thus, no second drive signal is needed for actuation of the second transducer of the acoustofluidic device. As no second drive signal is required, the amount of the circuit components, as e.g., amplifiers, may be decreased. Further, less energy may be required for driving/operating the acoustofluidic device. That is advantageous, because both the device and the operating process becomes cheaper and results in less environmental impact, compared to the methods and devices known in the art.

The frequency f may in the range of 0.1 to 20 MHz. The frequency range is particularly advantageous in use of the acoustofluidic device, as recognized in the art. More preferably, the frequency f may be in the range of 0.8 to 8 MHz, most preferably in the range of 1 to 5 MHz.

The acoustic resonance peak may correspond to three-dimensional volume resonance in the substrate including the microfluidic cavity, which three-dimensional volume resonance cannot be described as a one- or two-dimensional resonance in the substrate. Preferably, the frequency f does not correspond to a resonance frequency of the microfluidic cavity alone.

The method may be performed for separation and/or sorting and/or trapping of cells or other particles suspended in the fluid or liquid, and/or mixing of liquids or suspensions.

The acoustofluidic operation may comprise or consist of an acoustophoretic operation encompassing manipulating cells or other particles, e.g., comprising focusing cells or other particles, suspended in a suspension within the microfluidic cavity, towards one or more discrete areas of the microfluidic cavity. Focusing is to be understood as encompassing moving.

The first ultrasound transducer and the second ultrasound transducer may share a common first electrode.

It is understood that the wording “share a common electrode” encompasses “having an electrode in common” i.e., having a joint electricity leading element. That implies that the first electrode includes both the first electrode of the first transducer and the first electrode of the second transducer. The first electrode may be a rectangular electrode. The first electrode may comprise a first part, defining a first electrode of the first transducer, and a second part, defining first electrode of the second transducer. The first and the second part may be connected by a third part, the three parts thereby together defining a first electrode. The parts may differ from each other in size and/or form. The parts may differ from each other in material. Two of the parts may have similar characteristics, e.g., form, size, and/or material. The parts may be juxtaposed or being in line with each other, as seen in a vertical direction. The parts may lie aligned, as seen in a horizontal direction. The parts may be arranged not to be aligned as seen in a horizontal direction.

It is advantageous that the two transducers share a common electrode, as it makes the manufacturing of the device less complicated. Further, sharing a common electrode increases the electrical conductivity between the two transducers.

One or more electrodes may also be implemented using conductive adhesive or a conductive substrate material.

The drive circuit preferably may be configured to actuate the first and the second ultrasound transducer at a frequency f that corresponds to an acoustic resonance peak of one or more of the substrate, the microfluidic cavity filled with a fluid, and the transducers, as further described above.

It is understood that the expression “be configured to actuate . . . at a frequency f” means “being configured to provide and/or apply a signal having frequency f”. As described above, a signal generator may be considered comprising such a drive circuit.

The drive circuit may be configured to actuate the first and second ultrasound transducers by further being electrically connected to at least one, preferably both, of the second electrodes so as to apply the drive signal between the second electrodes.

The first ultrasound transducer and the second ultrasound transducer may share the piezoelectric or electrostrictive material. Such design of the acoustofluidic device allows an easier and faster manufacturing process.

It is understood that the wording “share the piezoelectric or electrostrictive material” means “having the piezoelectric or electrostrictive material in common”, i.e., having a joint layer or body of piezoelectric or electrostrictive material element. The layer or body may differ in dimensions throughout its extent. The layer or body may differ in material content throughout its extent.

The thickness of the first ultrasound transducer, defined as the distance between the first and second electrode of the first ultrasound transducer, may be different from the thickness of the second ultrasound transducer, defined as the distance between the first and second electrode of the second ultrasound transducer.

The differences in thickness may be advantageous for modulation of the signal propagation as the thickness between the first and second electrodes of the respective transducer influences the electrical field between said electrodes.

The first electrodes may be defined by a first common electrode layer provided on a first surface of the shared piezoelectric or electrostrictive material. Each of the second electrodes may be defined by second separate electrode patches provided on a second surface of the shared piezoelectric or electrostrictive material, and wherein a cut-out may be provided in the shared piezoelectric or electrostrictive material in the area between the second separate electrode patches.

The patches may be spaced apart on the layer such that a portion, such as 20%, such as 30%, such as 40%, such as 50%, such as 60%, of the area of the layer is not covered by the second electrodes. Preferably however all of the area of the layer, except the area of the surfaces of the cut-out, is covered by the second electrodes.

Such a configuration of the acoustofluidic device forces the drive signal to proceed from the second electrode of the first transducer to the first common electrode layer, rather than propagating through the shared piezoelectric or electrostrictive material directly to the second electrode of the second transducer.

The cut-out may be centered in the shared piezoelectric or electrostrictive material. Edges of the cut-out may differ in shape throughout its extent. At least one of the dimensions of the cut-out, as depth or width, may differ throughout its extent. The cut-out may be partial or extending from a side surface to an opposite side surface of the shared piezoelectric or electrostrictive material.

The second electrodes may be spaced apart by the cut-out on the layer of piezoelectric material such that a portion, such as 20%, such as 30&, such as 40%, such as 50%, of the piezoelectric material is not covered by the second electrodes.

The dipoles of the piezoelectric or electrostrictive material of the first and second ultrasound transducers are preferably aligned in orientation.

Groups of dipoles are initially randomly oriented in the raw piezoelectric or electrostrictive material, but can be aligned using a poling treatment. After poling, the electric dipoles align and roughly stay in alignment thus leaving a remnant polarization. As a result, there is a distortion that causes expansion in the direction of the electric field and a contraction along the axes normal to the electric field. Thus, it is understood that “aligned” means “sufficiently aligned” or “roughly aligned”, i.e., more aligned than prior to being poled.

Due to the differing directions of the electrical fields between the electrodes of the respective transducers, the piezoelectric or electrostrictive material of the first and second ultrasound transducers will behave in antiphase to each other. Alternatively, the dipoles of the piezoelectric or electrostrictive material of the first and second ultrasound transducers may be aligned in opposite orientations.

At least one of the first and the second ultrasound transducers may a thin film transducer, preferably having a thickness of less than 100 μm, such as less than 50 μm, such as less than 5 μm, such as less than 2 μm.

The thin film ultrasound transducers that may be used in the technology proposed herein typically have thicknesses of less than 100 μm, such as less than 10 μm, and therefore provide only a negligible influence on the resonance of the acoustofluidic device itself, in contrast to e.g., conventional bulk ultrasound transducers.

The ultrasound transducer may make up less than 0.001 of the total volume of the acoustofluidic device.

Typically, the microfluidic cavity has at least one minimum dimension, such as a width or height, and the thickness of the ultrasound transducer is smaller than the at least one minimum dimension.

The thin film ultrasound transducer may be deposited by first depositing a first electrode or electrode layer onto the surface. Then a layer of piezoelectric or electrostrictive material is deposited onto the first electrode or electrode layer. Finally, a second electrode or electrode layer deposited onto the layer of piezoelectric or electrostrictive material. As above, the first and second electrode or electrode layers should be made of an electrically conductive material such as a metal, for example platinum, silver, or gold. Additional layers may be included for facilitating attachment of the thin film ultrasound transducer to the substrate. As an example, a first layer of titanium (such as 1 nm) may be deposited on the substrate before an electrode or electrode layer is deposited. The thickness of the electrodes or electrode layers may vary. The electrode layers may for example have a thickness of 50 to 200 nm, such as 70 to 150 nm, such as 80-100 nm. Generally, the electrodes or electrode layers are therefore thinner than the material providing the ultrasound vibrations, i.e., typically the piezoelectric or electrostrictive material.

Preferably the thickness of the thin film ultrasound transducer is less than 10 μm, more preferably 5 μm or less, such as 0.01 to 5 μm, more preferably 3 μm or less, such as 0.5 to 3 μm, more preferably 2 μm or less, such as 0.5 to 2 μm, such as 0.5 to 1.5 μm, such as 1 μm or less than 1 μm. These thicknesses are typically less than ¼ of the wavelength, in the thin film ultrasound transducer material, for the acoustofluidic device resonance frequency used when actuating the acoustofluidic device to perform an acoustofluidic operation.

These are typical thicknesses for thin films. However, the thin film ultrasound transducer may be significantly thinner, such as down to one or more atomic or molecular monolayers. Generally, a thinner thin film ultrasound transducer may be easier to manufacture, whereas a thicker thin film ultrasound transducer may provide a stronger acoustofluidic effect in the microfluidic cavity.

In the context of the technology proposed herein the thickness of the thin film ultrasound transducer is the thickness of the material layer that provides the ultrasound vibrations. As an example, where the thin film ultrasound transducer comprises a layer of piezoelectric or electrostrictive material, the thickness of any electrode layer or layers used to deliver an electric signal to the layer of piezoelectric or electrostrictive material are not included in the thickness of the thin film ultrasound transducer.

The first electrode of the respective ultrasound transducer may be in a contact with the top surface of the piezoelectric or electrostrictive material, and the second electrode of the respective ultrasound transducer may in a contact with the bottom surface of the piezoelectric or electrostrictive material.

Further alternative aspects of the technology proposed herein concern an alternative method and device for performing an acoustofluidic operation. Specifically, and referring to the direction of the dipoles in the piezoelectric or electrostrictive material, the present inventors further noted that if a DC voltage, as opposed to an AC drive signal, is applied to the second electrodes in the method and device according to the first and second aspects of the present invention, then the dipoles of the piezoelectric or electrostrictive material of the respective first and second ultrasound transducers can be arranged (i.e. poled) in opposite directions/orientations.

Once the dipoles have been arranged in opposite directions, then an AC drive signal applied from the second electrodes to the first electrodes, will give rise to first and second electric fields over the respective first and second ultrasound transducers. These electrical fields will have the same direction. However, as the dipoles of the piezoelectric or electrostrictive material of the respective ultrasound transducers have opposite directions, then the behaviour of the respective ultrasound transducer in relation to the electrical fields will be opposite to each other. Accordingly, the first ultrasound transducer and the second ultrasound transducer, despite being subjected to electrical fields having the same direction, will be actuated, i.e., caused to vibrate, in antiphase with a 180° phase shift.

Accordingly, the alternative method according to the alternative aspect corresponds to the method according to the first aspect, with the difference that the direction of a majority of the dipoles of the first ultrasound transducer is opposite to the direction of a majority of the dipoles of the second ultrasound transducer, and the drive signal is applied between, on one side both second electrodes, and on the other side both first electrodes, whereby no electrode is left to float.

Accordingly, the alternative device according to the alternative aspect corresponds to the device according to the second aspect, with the difference that the direction of a majority of the dipoles of the first ultrasound transducer is opposite to the direction of a majority of the dipoles of the second ultrasound transducer, and the drive circuit is configured to apply the drive signal between, on one side both second electrodes, and on the other side both first electrodes, whereby no electrode is left to float.

The alternative method and device for performing an acoustofluidic operation solves the same problem as the method and device according to the first and second aspects of the technology proposed herein, however in an alternative way. Specifically, the alternative method and device also only require a single drive signal, thus reducing the number of electrical components needed. Further, the alternative method and device makes use of the same electrical connection scheme as the method and device of the first and second aspect but using a DC voltage when the dipoles of the piezoelectric or electrostrictive material of the respective first and second ultrasound transducers are to be arranged in opposite directions. The aspects of the technology proposed herein can be extended to more than two transducers.

The alternative method according to the alternative aspect may thus relate to a method of performing an acoustofluidic operation, comprising the steps of:
a. providing an acoustofluidic device comprising:
   a substrate in which a microfluidic cavity is positioned, and
   at least a first and a second ultrasound transducer, each provided in acoustic contact with the substrate for transferring ultrasonic vibrations to the substrate and causing the substrate to vibrate, wherein the first and the second ultrasound transducers each comprise a first electrode and a second electrode in contact with a piezoelectric or electrostrictive material, and wherein the first electrodes are in electric contact with each other,
wherein further the second electrodes are in contact with each other and the direction of a majority of the dipoles of the first ultrasound transducer is opposite to the direction of a majority of the dipoles of the second ultrasound transducer,
b. providing a fluid, such as a liquid or liquid suspension in the microfluidic cavity,
c. applying a drive signal between, on one side both second electrodes, and on the other side both first electrodes, wherein the drive signal has a frequency f that corresponds to an acoustic resonance peak of one or more of the substrate, the microfluidic cavity filled with a fluid, and the transducers.

The alternative device according to the alternative aspect may thus relate to an acoustofluidic device comprising:
a substrate in which a microfluidic cavity is positioned,
at least a first and a second ultrasound transducer, each provided in acoustic contact with the substrate for transferring ultrasonic vibrations to the substrate and causing the substrate to vibrate, wherein the first and the second ultrasound transducers each comprise a first electrode and a second electrode in contact with a piezoelectric or electrostrictive material, and wherein the first electrodes are in electric contact with each other,
wherein further the second electrodes are in contact with each other and the direction of a majority of the dipoles of the first ultrasound transducer is opposite to the direction of a majority of the dipoles of the second ultrasound transducer,
the device further comprising:
   a drive circuit configured to apply a drive signal between, on one side both second electrodes, and on the other side both first electrodes, wherein the drive signal has a frequency f that corresponds to an acoustic resonance peak of one or more of the substrate, the microfluidic cavity filled with a fluid, and the transducers.

The method according to the first aspect and the alternative method according to the alternative aspect may both be encompassed by a further alternative method of providing antisymmetrical, preferably antiphase, actuation of an acoustofluidic device, comprising the steps of:
a. providing an acoustofluidic device comprising
   a substrate in which a microfluidic cavity is positioned,
   a first and a second ultrasound transducer provided in acoustic contact with the substrate for transferring ultrasonic vibrations to the substrate and causing the substrate to vibrate,
   the first ultrasound transducer comprising a first piezoelectric or electrostrictive material in which a majority of the dipoles are directed in a first direction,
   the second ultrasound transducer comprising a second piezoelectric or electrostrictive material in which a majority of the dipoles are directed in a second direction,
b. providing a fluid, such as a liquid or liquid suspension in the microfluidic cavity,
c. using electrodes in contact with the first piezoelectric or electrostrictive material to apply a first electric field over the first piezoelectric or electrostrictive material
c. using electrodes contact with the second piezoelectric or electrostrictive material to apply a second electric field over the second piezoelectric or electrostrictive material,
   wherein the first electric field is directed in the same direction as first direction,
   wherein the second electric field is directed in the opposite direction to second direction, and

wherein the first and second electric fields are provided by a drive signal having a frequency f that corresponds to an acoustic resonance peak of one or more of the substrate, the microfluidic cavity filled with a fluid, and the transducers.

Accordingly, the differing directions of the second electric field and the second direction, and thereby the antisymmetrical actuation, may be obtained by using the floating electrode to obtain a change in direction between the first electrical field and the second electrical field, as per the method according to the first aspect, or by using opposite first and second directions of the majority of the dipoles in the respective first and second piezoelectric or electrostrictive materials, as per the alternative method according to the alternative aspect.

### BRIEF DESCRIPTION OF THE DRAWINGS AND DETAILED DESCRIPTION

A more complete understanding of the abovementioned and other features and advantages of the technology will be apparent from the following detailed description of preferred embodiments in conjunction with the appended drawings, wherein:

FIG. 1A shows the general construction of an acoustofluidic device and how the device may be connected to a function generator for actuation.

FIGS. 1B-1C show measured phase difference between the transducers of an acoustofluidic device according to FIG. 1A, wherein anti-symmetric or symmetric drive signals are applied to the transducers.

FIG. 2A shows the general construction of a first embodiment of an acoustofluidic device according to the second aspect of the technology proposed herein.

FIG. 2B shows the general construction of an embodiment of an acoustofluidic device according to the alternative aspect of the technology proposed herein.

FIG. 3 shows measured and normalized particle bandwidth as a function of applied frequency of the signal actuating the acoustofluidic device according to the first aspect of the technology proposed herein.

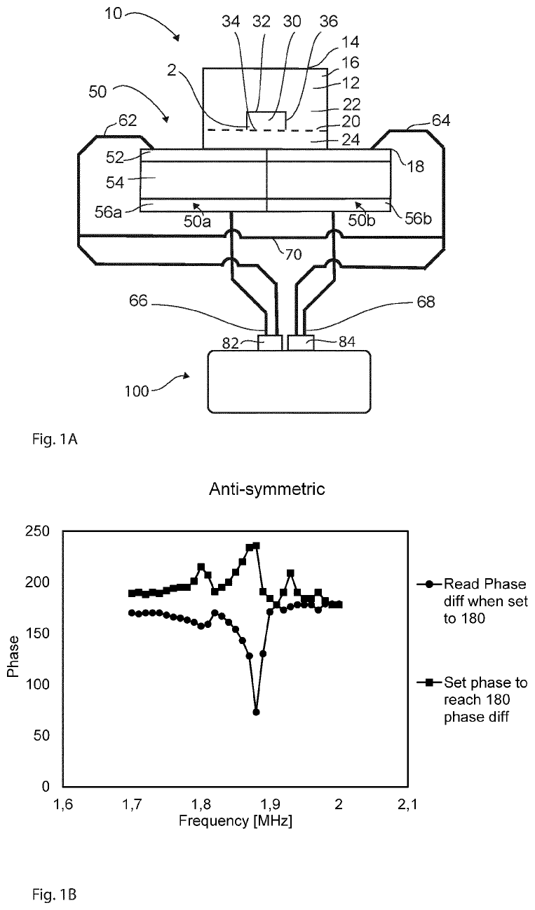

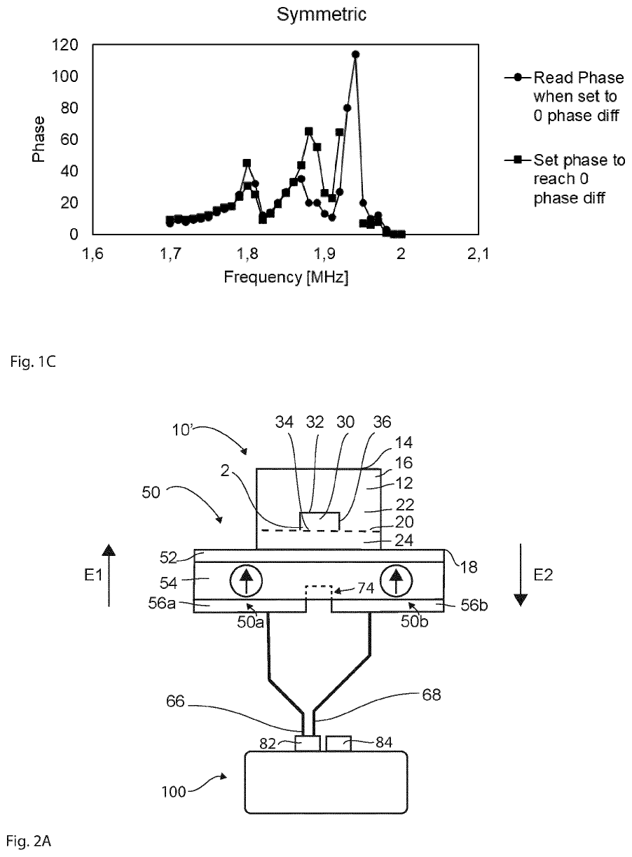

FIG. 1A shows a general construction of an acoustofluidic device 10 according to a conventional method of signal supply to the acoustofluidic device 10. Details of the substrate 12 and the microfluidic channel are discussed in relation to FIG. 2 below. A voltage is applied over respective first and second transducer 50a, 50b. A signal generator device 100, or drive circuit, is connected to a respective transducer 50a, 50b by two leads via the I/O ports 82, 84 of the drive circuit. The first one 62, 64 of the leads is connected to the first electrode 52, being most proximal in relation to the substrate 12. The first leads 62, 64 may be interconnected by a lead 70. The second one 66, 68 of the leads is connected to the second electrode 56a, 56b, being most distal in relation to the substrate. Thus, such circuitry makes it is possible for the signal generator to simultaneously apply two different voltages/signals to the acoustofluidic device 10, which signals may be in-phase, i.e., symmetric, or in antiphase, i.e., antisymmetric. The voltages/signals may be varied in amplitude, phase, or form when the acoustofluidic device is in use. Transducers 50a and 50b are isolated from each other.

FIGS. 1B-1C show measured phase difference between the two transducers of an acoustofluidic device as shown in FIG. 1A. The FIGS. 1B-1C illustrate that the largest offset from the set phase shift is present when operating the acoustofluidic device at approximately 1.88 Hz for the anti-symmetric actuation of the device. This frequency corresponds the measured resonance frequency of the system. The symmetric actuation, on the other hand, results in a maximum offset at 1.95 MHz. As noted by the present inventors, there was significant crosstalk between the ultrasound transducers where a set phase difference was not obtained when measured and vice versa.

The significant crosstalk between the transducers in FIG. 1A led the present inventors to the general construction of a first embodiment of an acoustofluidic device 10′ shown schematically and in cross section in FIG. 2A. Acoustofluidic device 10′ comprises a substrate 12 having a top surface 14, first and second opposing side surfaces, one of which is designated 16, as well as a bottom surface 18. Optionally, as shown by the hatched line 20, the substrate 12 may be formed of lid portion 22 and a base portion 24. A microfluidic cavity in the form of a microfluidic channel 30 is provided in the substrate 12, the channel 30 having a top wall 32 and a base wall 34, as well as opposing first and second sidewalls, one of which is designated 36. On the bottom surface 18 of the substrate 12 an ultrasound transducer 50 is attached. The ultrasound transducer 50 comprises a first common (top) electrode 52 in acoustic contact with the bottom surface 18 of the substrate 12, a piezoelectric or electrostrictive material 54 in contact with the first common electrode 52, and two second (bottom) electrodes 56a, 56b. In use, a fluid 2, such as a liquid or liquid suspension, is introduced and/or flowed through the channel 30.

FIG. 2A shows two (bottom) electrodes 56a and 56b. Together with the first common electrode(s) 52 and the piezoelectric or electrostrictive material 54, the electrodes 56a and 56b define two ultrasound transducers 50a and 50b which can be actuated asymmetrically, i.e., out of phase such as in antiphase.

The acoustofluidic device 10′ of FIG. 2A differs from that of FIG. 1A in that only one output 82 of the signal generator 100 is used. Accordingly, there is only one signal used to actuate the two ultrasound transducers. This signal is supplied between lead 66 and 68 to the second electrodes 56a and 56b. As described earlier, this signal is transferred capacitively and resistively to the common first top electrode 52 giving rise to first and second electric fields (indicated by arrows E1 and E2) between the second electrode 56a and the common first top electrode 52, and between the common first top electrode 52 and the second electrode 56b. The second electrical field E2 is consequently oppositely directed compared to the first electrical field E1. Either lead 66 or 68 may be held at a constant potential in relation to ground, such as being grounded to the ground of the signal generator 100. The common first top electrode 52 is left floating, i.e., not connected to any other potential. The general directions of the dipoles in the piezoelectric or electrostrictive material 54 for the respective transducers 50a and 50 b are indicated by circled arrows, which here show that the dipoles have the same general orientation. Due to relation between the direction of orientation of the dipoles in the respective transducers 50a and 50b and the electrical fields E1, E2, the transducers 50a and 50b will be actuated in an antisymmetric fashion, i.e., in antiphase. The actuation of the first and second transducers 50a and 50b causes the acoustofluidic device 10′ to vibrate, thereby giving rise to acoustic fields in the channel 30 which can be used to affect the fluid 2 including any particles in the fluid 2.

FIG. 2B shows the general construction of an embodiment an acoustofluidic device according to the alternative aspect of the technology proposed herein. The figure illustrates two (top) electrodes 56a and 56b. Together with the first electrode 52 and the piezoelectric or electrostrictive 54, the electrodes 56a and 56b define two ultrasound transducers 50a and 50b.

The acoustofluidic device of FIG. 2B differs from the embodiment illustrated in FIG. 2A in the connection of the transducers to the signal generation device. A voltage is applied over respective transducer 50a, 50b. A signal generator device 10 is connected to the second electrode 56 of respective transducer via a lead 66, 68. The respective lead is connected in parallel to the second electrode 56. A second lead 62 is connected to the first electrode 52, preferably being the most proximal in relation to the substrate. Thus, the signal generator 100 is configured to apply a voltage across each of the ultrasound transducers 50a, 50b.

If the dipoles of the piezoelectric or electrostrictive material 54 were aligned in the same direction in both ultrasound transducer 50a and 50b, then a symmetric actuation of the ultrasound transducers 50a, 50b would be obtained based on the first and second electrical fields E1 and E2 having the same direction in this device.

However, if a majority of the dipoles of the piezoelectric or electrostrictive material 54 in the first ultrasound transducer 50a were aligned in a direction that is opposite to the direction of a majority of the dipoles of the piezoelectric or electrostrictive material 54 in the second ultrasound transducer 50b, then an antisymmetric or antiphase actuation of the ultrasound transducers 50a and 50b would be obtained. This is the case here as shown by the general directions of the dipoles in the piezoelectric or electrostrictive material 54 shown by the circled arrows. Due to the relation between the direction of orientation of the dipoles in the respective transducers 50a and 50b and the direction of the electrical fields E1, E2, the transducers 50a and 50b will be actuated in an antisymmetric fashion, i.e., in antiphase, also in this device using only a single drive signal.

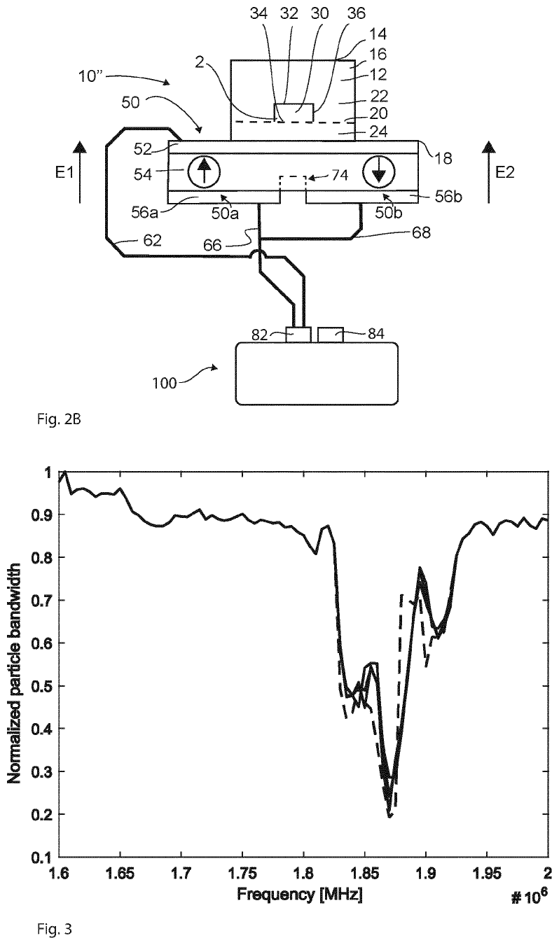

FIG. 3 shows normalized particle bandwidth as a function of the frequency of the signal applied. The dashed line represents results achieved using the acoustofluidic device 10 shown in FIG. 1A. All the other lines represent results achieved by using the device 10′ shown in FIG. 2A. The figure depictures a lower normalized particle bandwidth within the area between approximately 1.83 MHz and 1.92 MHz. The figure shows that applying a signal having the frequency of approximately 1.88 MHz provided the smallest particle bandwidth. The figure further illustrates that there is no significant difference between the achieved results. In other words, according to the experiments, the efficiency of a method using the device shown in FIG. 2A is similar to the results of a method using the device shown in FIG. 1A, but requires fewer electrical components.

### Feasible Modifications of the Technology Proposed Herein

The technology proposed herein is not limited to the embodiments described above and shown in the drawings, which primarily have an illustrative and exemplifying purpose. This patent application is intended to cover all adjustments and variants of the preferred embodiments described herein, thus the present invention is defined by the wording of the appended claims and the equivalents thereof. Thus, the equipment may be modified in all kinds of ways within the scope of the appended claims.

It shall also be pointed out that all information about/concerning terms such as above, under, upper, lower, etc., shall be interpreted/read having the equipment oriented according to the figures, having the drawings oriented such that the references can be properly read. Thus, such terms only indicate mutual relations in the shown embodiments, which relations may be changed if the inventive equipment is provided with another structure/design.

It shall also be pointed out that even thus it is not explicitly stated that features from a specific embodiment may be combined with features from another embodiment, the combination shall be considered obvious, if the combination is possible.

Throughout this specification and the claims which follows, unless the context requires otherwise, the word “comprise”, and variations such as “comprises” or “comprising”, will be understood to imply the inclusion of a stated integer or steps or group of integers or steps but not the exclusion of any other integer or step or group of integers or steps.

1-16: (canceled)

17. A method of performing an acoustofluidic operation, comprising the steps of:
(a) providing an acoustofluidic device, comprising:
(1) a substrate having a microfluidic cavity; and
(2) a first ultrasound transducer and a second ultrasound transducer, each of the ultrasound transducers being in acoustic contact with the substrate so as to transfer ultrasonic vibrations to the substrate, thereby causing the substrate to vibrate; wherein each of the ultrasound transducers comprises a first electrode and a second electrode in contact with a piezoelectric or electrostrictive material, wherein the first electrodes of the first and second ultrasound transducers are in electric contact with each other, and wherein each of the first electrodes has an electrical potential;
(b) providing a fluid in the microfluidic cavity;
(c) applying a drive signal between the second electrodes of each of the ultrasound transducers, wherein the drive signal has a frequency f that corresponds to an acoustic resonance peak of one or more of the substrate, the microfluidic cavity containing the fluid, and the first and second ultrasound transducers; and
(d) letting the electrical potential of each of the first electrodes float.

18. The method according to claim 17, wherein the second electrode of the second ultrasound transducer is held at a constant voltage in relation to ground.

19. The method according to claim 17, wherein the second electrode of the second ultrasound transducer is grounded.

20. The method according to claim 17, wherein the frequency f is in the range of 0.1 to 20 MHz.

21. The method according to claim 17, wherein the acoustic resonance peak corresponds to a three-dimensional volume resonance in the substrate including the microfluidic cavity, which three-dimensional volume resonance can be described as neither a one-dimensional resonance in the substrate nor a two-dimensional resonance in the substrate.

22. The method according to claim 17, wherein the frequency f does not correspond to a resonance frequency of the microfluidic cavity alone.

23. The method according to claim 17, wherein the fluid comprises a liquid with particles suspended therein.

24. The method according to claim 23, wherein the acoustofluidic operation is selected from the group consisting of one or more of separating the particles suspended in the liquid, sorting the particles suspended in the liquid, trapping the particles suspended in the liquid, and mixing the particles suspended in the liquid.

25. The method according to claim 23, wherein the liquid comprises two or more liquids, and the operation is selected from the group consisting of mixing the two or more liquids, and mixing the particles suspended in the two or more liquids.

26. An acoustofluidic device, comprising:
a substrate having a microfluidic cavity;
a first ultrasound transducer and a second ultrasound transducer, each of the ultrasound transducers being in acoustic contact with the substrate so as to transfer ultrasonic vibrations to the substrate, thereby causing the substrate to vibrate, wherein each of the ultrasound transducers comprises a first electrode and a second electrode in contact with a piezoelectric or electrostrictive material, wherein the first electrodes of the first and second ultrasound transducers are in electric contact with each other, and wherein each of the first and second electrodes has an electrical potential; and
a drive circuit configured to apply a drive signal between the second electrodes of each of the first and second ultrasound transducers, wherein the first electrode of each of the first and second ultrasound transducers is configured to have an electrical potential that is floating in relation to ground.

27. The acoustofluidic device according to claim 26, wherein the first and second ultrasound transducers share a common first electrode.

28. The acoustofluidic device according to claim 26, wherein the drive circuit is configured to actuate each of the first and second ultrasound transducers at a frequency f that corresponds to an acoustic resonance peak of one or more of the substrate, the microfluidic cavity when it contains a fluid, and the first and second ultrasound transducers.

29. The acoustofluidic device according to claim 26, wherein the first and second ultrasound transducers share the piezoelectric or electrostrictive material.

30. The acoustofluidic device according to claim 29, wherein the first ultrasound transducer has a first thickness, defined as the distance between the first and second electrodes of the first ultrasound transducer, wherein the second ultrasound transducer has a second thickness, defined as the distance between the first and second electrodes of the second ultrasound transducer, and wherein the first and second thicknesses are different from each other.

31. The acoustofluidic device according to claim 29, wherein each of the first electrodes is defined by a first common electrode layer provided on a first surface of the shared piezoelectric or electrostrictive material, wherein the second electrode of each of the first and second ultrasound transducers is defined by a separate electrode patch on a second surface of the shared piezoelectric or electrostrictive material, and wherein a cut-out is provided in the shared piezoelectric or electrostrictive material between the separate electrode patches.

32. The acoustofluidic device according to claim 26, wherein the piezoelectric or electrostrictive material has dipoles that are aligned in orientation.

33. The acoustofluidic device according to claim 26, wherein at least one of the first and second ultrasound transducers is a thin film transducer having a thickness of less than 100 μm.

34. The acoustofluidic device according to claim 26, wherein the first electrode of each of the first and second ultrasound transducers is in contact with a first surface of the piezoelectric or electrostrictive material, wherein the second electrode of each of the first and second ultrasound transducers is in contact with a second surface of the piezoelectric or electrostrictive material, and wherein the first surface is in contact with the substrate, and the second surface is opposite the first surface.

35. The acoustofluidic device according to claim 26, wherein the first electrode of each of the first and second ultrasound transducers is isolated from ground.

36. The acoustofluidic device according to claim 26, wherein the substrate comprises a base substrate, wherein the microfluidic cavity comprises a groove, and wherein a lid substrate is attached to the base substrate so as to cover the groove.
